(19) United States
(12) Patent Application Publication
(10) Pub. No.: US 2013/0004061 A1
(43) Pub. Date: Jan. 3, 2013

(54) IMAGE PROCESSING DEVICE, IMAGE PROCESSING PROGRAM, AND METHOD FOR GENERATING IMAGE

(75) Inventors: Masaru Sakurai, Nagoya (JP); Tomio Goto, Nagoya (JP); Akihiro Yoshikawa, Uji (JP)

(73) Assignee: NATIONAL UNIVERSITY CORPORATION NAGOYA INSTITUTE OF TECHNOLOGY, Nagoya-shi (JP)

(21) Appl. No.: 13/583,846

(22) PCT Filed: Mar. 11, 2011
(86) PCT No.: PCT/JP2011/055776

§ 371 Date: Sep. 10, 2012

(30) Foreign Application Priority Data
Mar. 12, 2010 (JP) 2010-056571

(51) Int. Cl. G06K 9/62

(52) U.S. Cl. 382/159

(57) ABSTRACT

An image processing device includes a texture component up-sampling portion for up-sampling a texture component of an input image and a component mixing portion for mixing an up-sampled structure component of the input image and the up-sampled texture component obtained by the texture component up-sampling portion, wherein the texture component up-sampling portion up-samples the texture component by means of a learning-based method using a reference image.

### TECHNICAL FIELD

The present invention is related to an image processing device and an image processing program for processing an image such as a television image, a digital camera image, and a medical image, and also a method for generating an image.

### BACKGROUND ART

NPLs 1 to 3 (which are incorporated to this specification by reference) disclose image up-sampling methods using a total variation (hereinafter referred to as TV) regularization method which are very useful ones of super-resolution image up-sampling methods for a television image and a digital camera, image.

FIG. 7 shows a composition of an image processing device for up-sampling an image by means of the TV regularization method. An input image is decomposed into a structure component and a texture component (each of which has the same number of pixels with the input image) at a TV regularization decomposing portion 1. The structure component is transformed to an up-sampled structure component at a TV regularization up-sampling portion 2. The texture component is transformed to an up-sampled texture component at a linear interpolation up-sampling portion 3. The up-sampled structure portion and the up-sampled texture component are mixed at a component mixing portion 4 and a final up-sampled image is thus obtained.

FIG. 8 is a flowchart showing processes of the TV regularization decomposing portion 1. When the input image fij (wherein f denotes a value of a pixel, and i and j are subscripts denoting horizontal and vertical position of the pixel, respectively) is inputted, a calculation count N is initialized to zero at step 101, and then a correction term a for a TV regularization calculation is calculated at step 102 as is shown by the equation in the drawing. λ is a predetermined regularization parameter, a summation diagram (Σ) denotes a total sum over all pixels, and a nabla (∇) is a well-known vector differential operator where x direction and y direction corresponds to the horizontal direction and the vertical direction, respectively. In step 103, a pixel value uij(N) is updated to a new pixel value uij(N+1) by means of −εα, wherein u is a value of a pixel and i and j are subscripts denoting horizontal and vertical position of the pixel, respectively. Then, the calculation count N is incremented in step 104 and it is determined at step 105 whether the incremented calculation count N has reached a predetermined value Nstop. If N has not reached the value Nstop, the operation returns to step 102. If N has reached the value Nstop, the updated pixel value uij is outputted as a final structure component, and the updated pixel value uij is subtracted from the input image fij and a texture component vij is thereby outputted in step 106. An initial value of u which is denoted as uij(0) is, for example, set to be equal to the input image fij.

The image up-sampling methods disclosed in the NPLs 1 to 3 include two TV regularization calculation processing portions which require a large amount of calculation time in executing iterative calculations. These two portions are the TV regularization decomposing portion 1 which decomposes the input image to the structure component and the texture component by means of the TV regularization method, and the TV regularization up-sampling portion 2 using the TV regularization method.

In view of this, the present inventors previously proposed an art disclosed in PTL 1 (which is incorporated to this specification by reference) which is aimed for reducing a total calculation time of an image processing device which up-sampling an image by means of the TV regularization method. FIG. 9 shows a composition of this image processing device. This art which is disclosed in PTL 1 and described below was not a publicly known art at Mar. 3, 2010.

This image processing device includes a TV regularization up-sampling portion 5 for obtaining an up-sampled structure component based on an input image, wherein the up-sampled structure component is an image expressing a structure portion of the input image and having a larger number of samples than the input image. In addition, this image processing device includes a down-sampling portion 7 for down-sampling the up-sampled structure component obtained by the TV regularization up-sampling portion 5 and thereby obtaining a structure component having the same number of samples as the input image, a subtraction portion 6 for subtracting the structure component obtained by the down-sampling portion 7 from the input image to obtain a texture component, a linear interpolation up-sampling portion 8 for increasing the number of samples of (i.e. up-sampling) the texture component obtained by the subtraction portion 6 by means of interpolation and thereby obtaining an up-sampled texture component, and a component mixing portion 9 for mixing the up-sampled structure component obtained by the TV regularization up-sampling portion 5 and the up-sampled texture component obtained by the linear interpolation up-sampling portion 8 and thereby obtaining an up-sampled output image.

This image processing device operates as follows. The input image is transformed to the up-sampled structure component at the TV regularization up-sampling portion 5. The up-sampled structure component is transformed at the down-sampling portion 7 to an image having the same number of pixels as the original input image in accordance with reduction of the number of pixels of the up-sampled structure component as shown in FIG. 10. For example, by down-sampling an up-sampled image at the left side of the drawing having 6 pixels×6 pixels, the pixels denoted by black spots are discarded and a half-size image having 3 pixels×3 pixels is constructed. The structure component obtained by the down-sampling is subtracted from the input image and the texture component is thereby obtained. The texture component is transformed to the up-sampled texture component at the linear interpolation up-sampling portion 8. The up-sampled structure component and the up-sampled texture component are mixed at the component mixing portion 9 to become a final up-sampled image.

FIG. 11 shows processes at the TV regularization up-sampling portion 5. In order to execute up-sampling calculation, the TV regularization up-sampling portion 5 executes calculation in which the number of pixels of u is increased to become 4 times as many as that of the input image by doubling the numbers of i and j. This type of up-sampling calculation is the same as the calculation in the TV regularization up-sampling portion 2 in FIG. 7. More specifically, the up-sampling calculation is executed as follows.

First, a calculation count N is initialized to become zero in step 201, and after that, a correction term a for a TV regularization calculation is calculated in step 202 as is shown in the equation in the drawing. However, since an up-sampling calculation is executed here, the number of pixels of uij is n×n times (for example, 2×2=4 times) as many as that of the input image. Therefore, in step 202, the second term u*ij(N) in the right side member is down-sampled, for example, as is shown in FIG. 10, so that the number of pixels (that is, the number of samples) of u*ij(N) becomes as many as that of the input image fij. In step 203, the image value uij(N) is updated to become a new image value uij(N+1) by means of −εα. Then, the calculation count N is incremented in step 204 and it is determined at step 205 whether the incremented calculation count N has reached a predetermined value Nstop. If N has not reached the value Nstop, the operation returns to step 202. If N has reached the value Nstop, the updated pixel value uij is outputted as a final structure component. It should be noted that the TV regularization up-sampling portion 2 in FIG. 7 and the TV regularization up-sampling portion 5 in FIG. 9 executes the same processes for an image to be inputted although they differ in whether the image to be inputted is the structure component or the input image fij.0.

Since the TV regularization decomposing portion 1 which requires a large amount of calculation time is discarded in this embodiment compared to the image processing device in FIG. 7, it is possible to drastically reduce an amount of calculation and decrease a total calculation time, for example, by half.

### CITATION LIST

### Patent Literature

[PTL 1]: Japanese Patent Application No. JP-2010-42639

### Non Patent Literature

[NPL 1]: Takahiro Saito: “Super Resolution Oversampling from a single image”, Journal of the Institute of Image Information and Television Engineers, Vol. 62 No. 2, pp. 181-189, 2008
[NPL 2]: Yuki Ishii, Yousuke Nakagawa, Takashi Komatsu, and Takahiro Saito: “Application of Multiplicative Skeleton/Texture Image Decomposition to Image Processing”, IEICE Trans., Vol. J90-D, No. 7, pp. 1682-1685, 2007
[NPL 3]: T. Saito and T. Komatsu: “Image Processing Approach Based on Nolinear Image-Decomposition”, IEICE Trans. Fundamentals, Vol. E92-A, No. 3, pp. 696-707, March 2009

### SUMMARY OF INVENTION

### Technical Problem

In the image up-sampling methods of the image processing devices depicted in FIGS. 7 and 9 use linear interpolation in obtaining the up-sampled texture components from the texture components. This up-sampling method using the linear interpolation have a problem that it cannot improve resolution of an image since it uses information of an original image even if it increases the number of pixels of the original image.

In view of this, it is an object of the present invention to improve resolution of an image by using an image processing device for up-sampling the image.

### Solution to Problem

A method referred to as a learning-based method (or, an example learning method) are widely studied in order to achieve improvement of resolution which cannot be realized by image up-sampling methods using linear interpolation. A basic principle of this method is described below. First, an input image is decomposed into a low frequency component image and a high frequency component image by a linear filter, and the low frequency component image is up-sampled by means of a linear interpolation method while the high frequency component image is up-sampled by means of a learning based method. Since high-definition quality cannot be expected if the high frequency component image is up-sampled by linear interpolation, a reference up-sampled high frequency component image is prepared which is different from the input image. As the reference up-sampled high frequency component image, an image including many high frequency components (high definition components) is selected. A reference high frequency image having the same number of pixels as the input image is generated by down-sampling the reference up-sampled high frequency component image. A degree of similarity is then calculated by correlation calculations between sub-images which is obtained by dividing the reference high frequency component image and the inputted high frequency component image into blocks (or called as “patches”), and at least one block having a high degree of similarity is selected. A single block having the highest degree of similarity or a top plurality of blocks having the highest degree of similarity may be selected. Next, at least one block of the reference up-sampled high frequency image corresponding to the selected at lest one block is used to form a block of the up-sampled high frequency image. By doing this way, information having a high similarity in the reference high frequency up-sampled component image is incorporated to each block of the up-sampled high frequency component image, and a high definition image is thereby obtained.

Accurate restoration of an edge component is one of major challenges in this learning-based method. This is because the high frequency component image is separated by the linear filter. A component having large energy and a large peak value is included in a part corresponding to the edge component of the high frequency component image. FIG. 12 shows this feature. A large amount of effort is necessary in order to calculate an image similar to the edge component. For example, attempts such as reducing the size of the blocks (which causes increase of calculation time) and increasing the number of reference images (which causes increase of memory and calculation time) have been made. However, even with these attempts, it is still difficult to find an image similar to the edge component since the edge component has a large peak value. Therefore, some input images result in degradation of image quality at a vicinity of the edge component. There has been a great difficulty in overcoming this problem.

The present invention solves this essential defect of the learning-based method. This invention has a notable feature that it does not use the high frequency component separated by filtering of an image but uses a texture component separated by the TV regularization means or the like. When an image is decomposed into a structure component and a texture component, the edge component is included in the structure component while the texture component hardly include the edge component having large peak values. FIG. 12 shows this feature. When the learning-based method is applied to the texture component, the above-described degradation of image quality caused by the edge component hardly occur. Therefore, attempts (reducing the size of the blocks, increasing the number of reference images) to overcome the degradation become unnecessary and calculation time is drastically shortened. On the other hand, the edge component does not cause any problem in the TV regularization up-sampling method because the edge component is up-sampled with idealized super-resolution by the TV regularization up-sampling method.

Consequently, idealized super-resolution is achieved in which the edge component and the texture component does not suffer degradation of image quality. In addition, calculation time is expected to be suppressed.

This invention which is based on the above deliberation is an image processing device including: a texture component up-sampling means (10, 20) for up-sampling a texture component of an input image; and a component mixing means (4, 9) for mixing an up-sampled structure component of the input image and the up-sampled texture component obtained by the texture component up-sampling means (10, 20), wherein the texture component up-sampling means (10, 20) up-samples the texture component by means of a learning-based method using a reference image. With this invention, it is possible to improve image quality by up-sampling the texture component by means of the learning-based method.

The up-sampled structure component and the texture component may be obtained by means of a TV regularization method.

The reference image may be a texture component image having similar features to the texture component of the input image.

The image processing device may include a structure component up-sampling means (2) for up-sampling a structure component of the input image, wherein the component mixing means (4, 9) mixes the up-sampled structure component obtained by the structure component up-sampling means (2) and the up-sampled texture component obtained by the texture component up-sampling means (10, 20).

Otherwise, the image processing device may include an up-sampled structure component obtaining means (5) for obtaining the up-sampled structure component based on the input image; a down-sampling means (7) for down-sampling the up-sampled structure component and thereby obtain a structure component having the same number of samples as the input image; and a subtracting means (6) for obtaining the texture component by subtracting the structure component obtained by the down-sampling means (7) from the input image, wherein the texture component up-sampling means (10, 20) up-samples the texture component obtained by the subtracting means (6).

With this invention, the image processing device for up-sampling an image by means of the TV regularization method can shorten total calculation time compared to that constructed as shown in FIG. 7. Furthermore, it can improve image resolution by up-sampling the texture component by means of the learning-based method.

The above-described texture component up-sampling means (10, 20) may include: a storage means for storing a reference low-resolution image which is obtained by down-sampling the reference image and a reference high-resolution image serving as the reference image; and a means for selecting, for each of original blocks obtained by dividing an image based on the texture component into blocks, at least one reference block similar to the original block out of reference blocks obtained by dividing the reference low-resolution image into blocks, and forming a block of the up-sampled texture component corresponding to the original block by using at least one block of the reference high-resolution image corresponding to the at least one reference block.

In this case, the means for selecting may select, for each of the original blocks, a reference block which is most similar to the original block of all of the reference blocks, selects a block of the reference high-resolution image corresponding to the selected reference block, and form a block of the up-sampled texture component corresponding to the original block by using the selected block.

In this case, the texture component up-sampling means (10, 20) may include a linear interpolation up-sampling means for obtaining the up-sampled texture component based on the input image by means of linear interpolation, and the means for selecting selects, for each of the original blocks, at least one reference block similar to the original block out of the reference blocks, and forms a block of the up-sampled texture component corresponding to the original block by using both of at least one block of the reference high-resolution image corresponding to the at least one reference block and a block corresponding to the original block in the up-sampled texture component obtained by the linear interpolation up-sampling means, if the reference blocks includes at least one reference block having a degree of similarity to the original block being larger than a predetermined value, and the means for selecting forms a block of the up-sampled texture component corresponding to the original block by not using the reference blocks but using a block corresponding to the original block in the up-sampled texture component obtained by the linear interpolation up-sampling means if the reference blocks does not include a reference block having a degree of similarity to the original block being larger than the predetermined value. This feature is favorable in improving resolution of an image.

These features of the image processing device may also be understood as features of a program or a method for generating an image.

### BRIEF DESCRIPTION OF DRAWINGS

FIG. 1 is a diagram showing a composition of an image processing device according to a first embodiment of the present invention.

FIG. 2 is a diagram showing a composition of an image processing device according to a second embodiment of the present invention.

FIG. 3 is a diagram showing how a learning-based up-sampling portion 10 in FIGS. 1 and 2 works.

FIG. 4 is a diagram showing how signals are inputted/outputted at the learning-based up-sampling portion 10.

FIG. 5 is a flowchart showing processes executed by the learning-based up-sampling portion 10.

FIG. 6 is a diagram showing a composition of an image processing device according to a third embodiment of the present invention.

FIG. 7 is an overall composition of an image processing device according to a prior art.

FIG. 8 is a flowchart showing processes executed by a TV regularization decomposing portion 1 in FIG. 7.

FIG. 9 is diagram showing a composition of an image processing device according to an invention previously proposed by the present inventors.

FIG. 10 is a diagram for illustrating down-sampling.

FIG. 11 a flowchart showing processes executed by a TV regularization up-sampling portion 5 in FIG. 9.

FIG. 11 is a diagram for illustrating a problem of former arts and features of the present invention.

### DESCRIPTION OF EMBODIMENTS

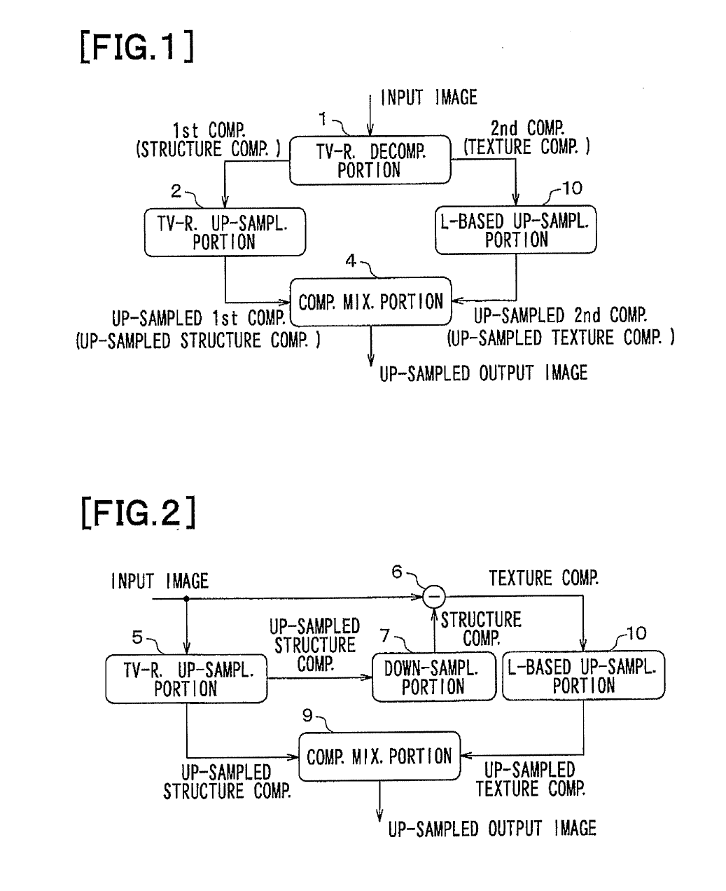

FIG. 1 is a diagram showing a composition of an image processing device according to a first embodiment of the present invention, and FIG. 2 is a diagram showing a composition of an image processing device according to a second embodiment of the present invention.

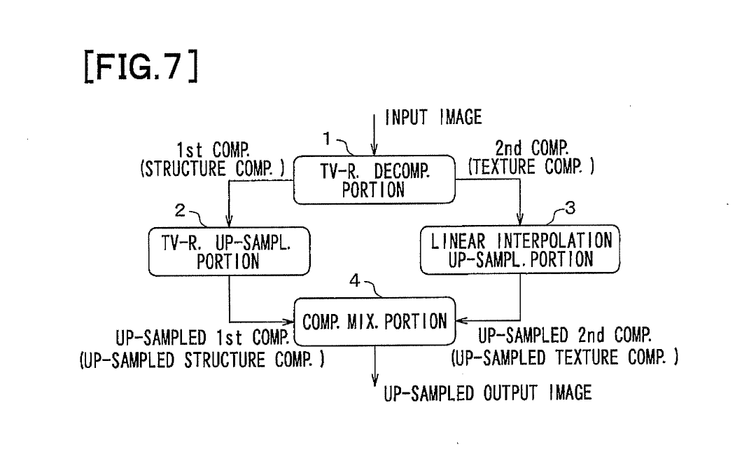

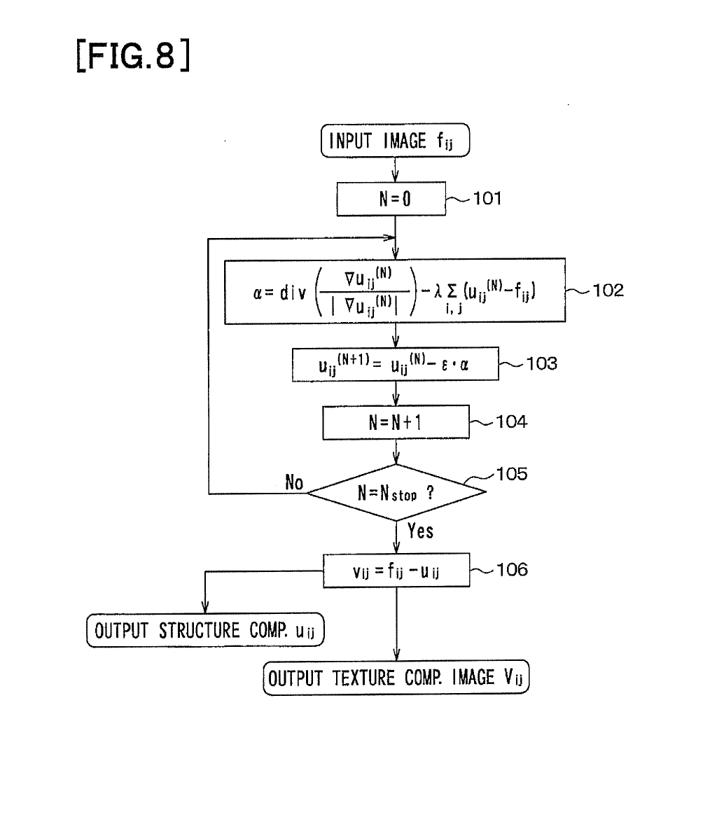

In the first embodiment shown in FIG. 1, a learning-based up-sampling portion 10 is used in place of the linear interpolation up-sampling portion 3 shown in FIG. 7.

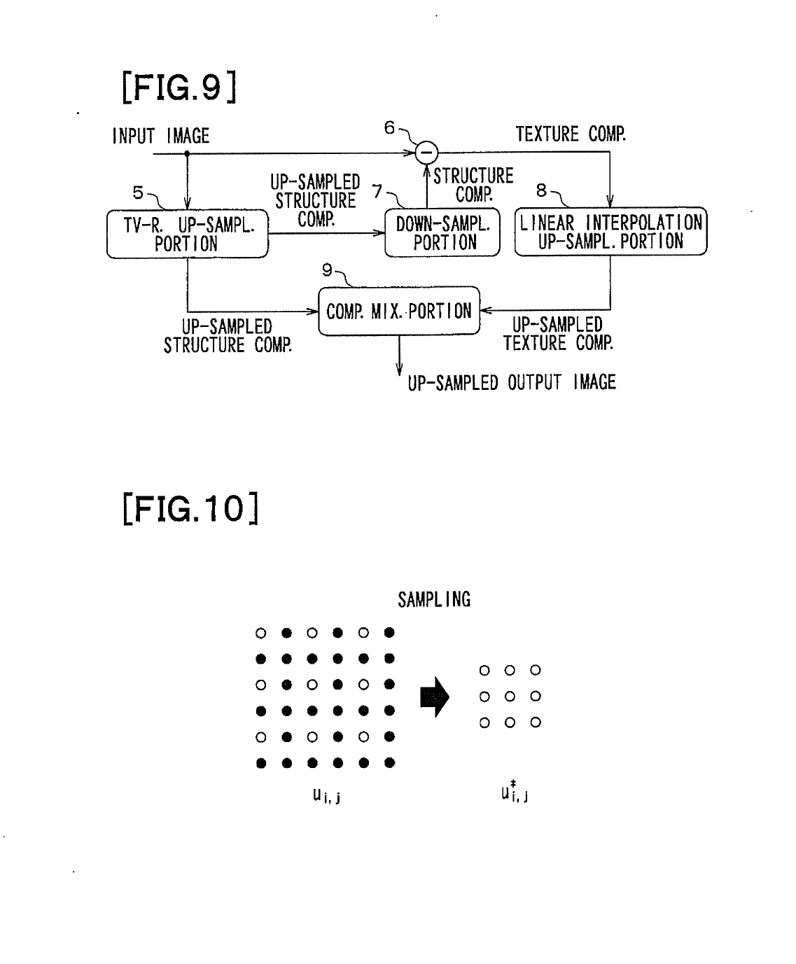

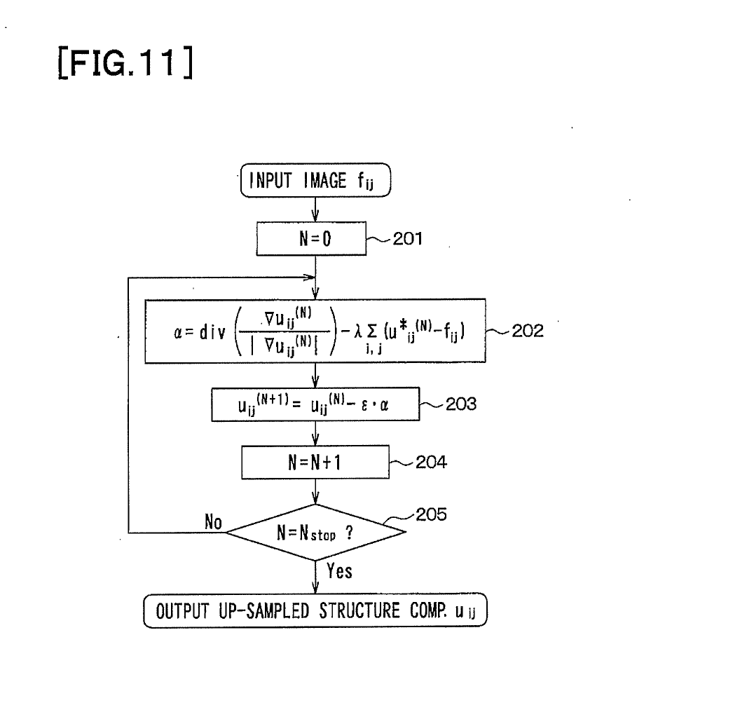

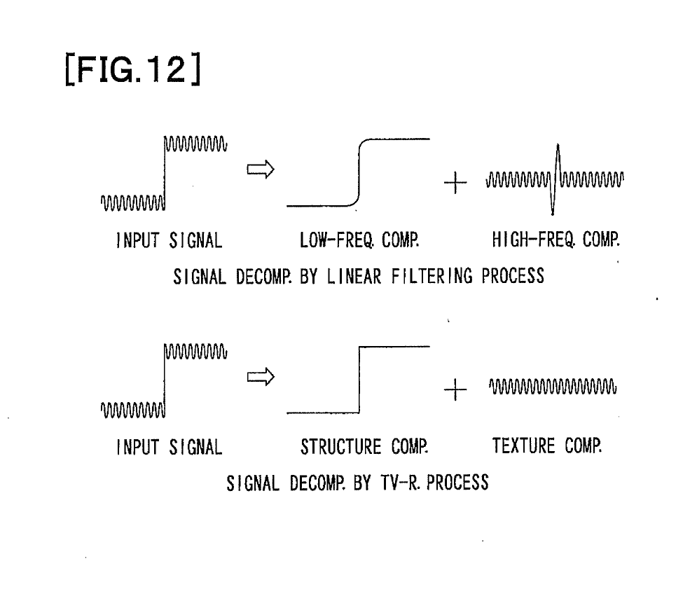

In the second embodiment shown in FIG. 2, a learning-based up-sampling portion 10 is used in place of the linear interpolation up-sampling portion 8 shown in FIG. 9. More specifically, an up-sampled structure component is obtained at the TV regularization up-sampling portion 2 or the TV regularization up-sampling portion 5 by means of a TV up-sampling method utilizing a TV regularization method, and a texture component is up-sampled by means of a learning-based method. The up-sampled structure component is an image expressing a structure component of an input image and is also an image having the larger number of samples than the input mage. The structure component of the input image is an image mainly including a low frequency component and an edge component, and the texture component of the input image is an image obtained by removing the structure component from the input image and is also an image mainly including a high frequency component. While up-sampling of the linear interpolation up-sampling portion does not improve resolution of an image, the learning-based method improves resolution and provides a super-resolution image. The resolution is determined by frequency range of an image signal expressing the pixels.

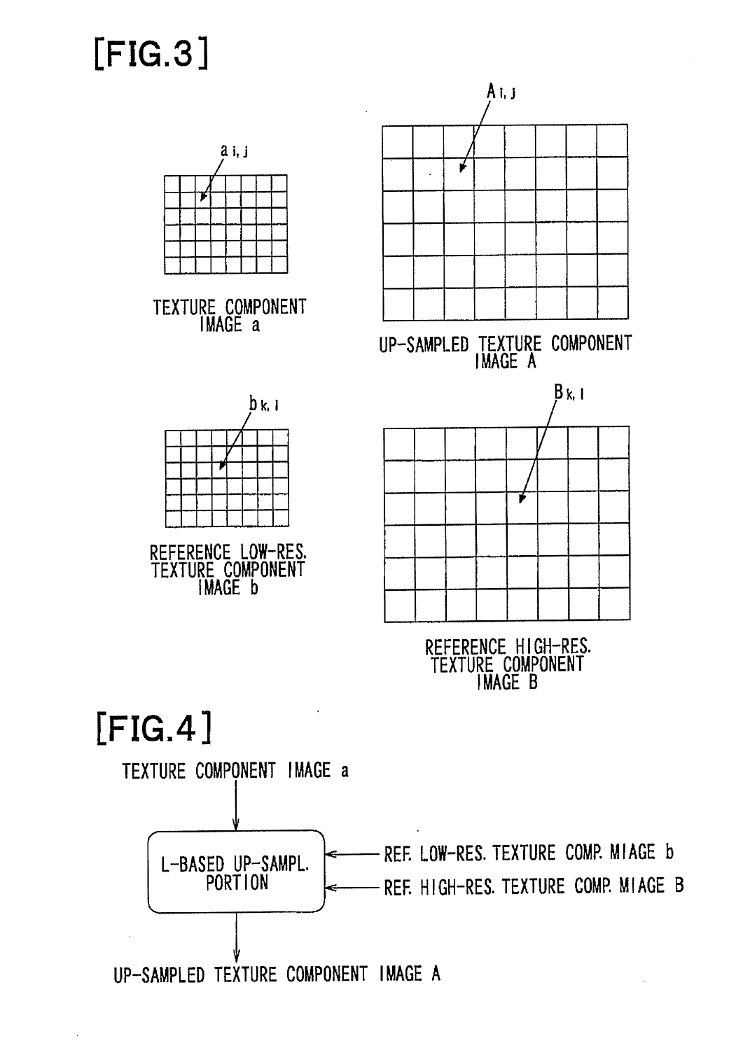

FIG. 3 shows how the learning-based up-sampling portion 10 works. an input texture component image a is stored in a storage device such as RAM (which can be contained in the learning-based portion 10 or be at the exterior of the learning-based portion 10) and divided into blocks ai,j (hereinafter referred to as original blocks) each having 4×4 pixels. In the case that the image a includes M×M pixels in total, the number of the original blocks is M/4×M/4. The learning-based up-sampling portion 10 generates and store in the storage device such as RAM an up-sampled texture component image A which is obtained by up-sampling by two the input texture component image inputted to the learning-based up-sampling portion 10. The learning-based up-sampling portion 10 divides the up-sampled texture component image A into blocks Ai,j which correspond one-to-one to the original blocks ai,j of the input texture component image a. Therefore, the up-sampled texture component image A consists of the blocks Ai,j each having 8×8 pixels wherein the number of the blocks Aij is M/4×M/4. Therefore, a block Ai,j corresponding to an original block ai,j is an image which can be obtained by up-sampling this original block ai,j by 2 in the vertical and the horizontal directions.

On the other hand, a reference high-resolution texture component image B and a reference low-resolution texture component image b which is obtained by down-sampling the reference high-resolution texture component image B are prepared and stored in advance in a storage device such as ROM (which can be contained in the learning-based portion 10 or be at the exterior of the learning-based portion 10). The reference texture component images B and b have no relation with the input image. Each of the image b and B is divided into blocks as is done for the images a and A, respectively. It should be noted that the reference texture component images B and b which are prepared in advance may favorably include high frequency range components. For example, the reference texture component images B and b may favorably have fine patterns. In an actual situation, each of the reference texture component images B and b is not prepared as a single image but a large number of images which are different from each other. A single reference high-resolution texture component image B may be generated by preparing in advance a device having the same configuration as one in FIG. 1, inputting a predetermined image having the same number of pixels with the reference high-resolution texture component image B into the TV regularization decomposing portion 1 of the prepared device, and using a texture component which is accordingly generated by the TV regularization decomposing portion 1 as the reference high-resolution texture component image B. Otherwise, a single reference high-resolution texture component image B may be generated by preparing in advance a device having the same configuration as one in FIG. 2, inputting the predetermined image into the TV regularization up-sampling portion 5 of the prepared device, and using a texture component which was accordingly outputted by subtracting portion as the reference high-resolution texture component image B.

The leaning-based up-sampling portion 10 reads the original blocks ai,j of the texture component image a one by one from the storage device such as the RAM and performs comparison by calculating a difference between each of the read original blocks ai,j and every block bk,l (hereinafter referred to as reference block bk,l) of every reference low-resolution texture component image b in the storage device such as the ROM. Comparison between an original block ai,j and a reference block bk.l is made, for example, by calculating absolute differences wherein an absolute difference is an absolute value of a difference between values of a pixel in this original block ai,j and a corresponding pixel in this reference block bk,l both of which represent the same position and by obtaining a summed difference which is a sum of the absolute differences of all pixels in a block. Then, the learning-based up-sampling portion 10 selects one reference block bk,l having the smallest summed difference, that is, having the most similar image to each original block ai,j. Subsequently, the learning-based up-sampling portion 10 selects a block Bk,l which corresponds to the selected reference block bk,l in a reference high-resolution texture component image B. Then, the learning-based up-sampling portion 10 replaces the block Ai,j of the up-sampled texture component image A with the selected block Bk,l in the storage device such as the ROM. This operation is repeated with i varied from 1 to M/4 and j varied from 1 to M/4. As a result of this operation, every block of the up-sampled texture component image A is replaced with a similar block in the reference high-resolution texture component image B.

FIG. 4 shows how signals are inputted/outputted at the learning-based up-sampling portion 10. The reference low-resolution texture component image b and the reference high-resolution texture component image B are provided from the storage device such as the ROM (which corresponds to a storage means), and the learning-based up-sampling portion 10 reads these images B and b from the storage means and performs processes described below.

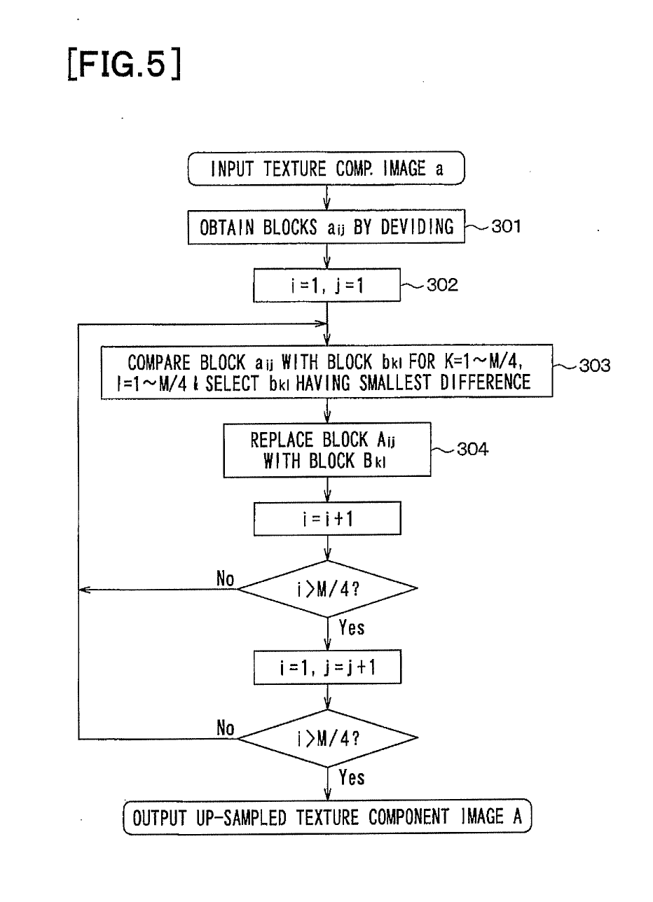

FIG. 5 shows processes performed by the learning-based up-sampling portion 10. Although it is not shown in FIG. 5, it should be noted that, in generating the up-sampled texture component image A, the learning-based up-sampling portion 10 prepares, before performing the processes in FIG. 5, an up-sampled texture component image by up-sampling the input texture component image a by means of linear interpolation executed at a linear interpolation up-sampling portion (the linear interpolation up-sampling portion 3 in FIG. 7 or the linear interpolation up-sampling portion 8 in FIG. 9).

In the processes in FIG. 5, the learning-based up-sampling portion 10 divides the input texture component image to generate the original blocks ai,j (wherein i ranges from 1 to M/4 and j ranges from 1 to M/4) at step 301. After i and j are set to 1 and 1 respectively at step 302, an original block ai,j and every reference block bk.l of the reference low-resolution texture component image b are compared, and a reference block bk,l having the smallest summed difference—that is, having the most similar image to each original block ai,j—is selected at step 303. Then, at step 304, a block Bk,l corresponding to the selected reference block bk.l is selected from the reference high-resolution texture component images B, and a corresponding block Ai,j of the prepared up-sampled texture component image A is replaced with the selected block Bk,l. The processes in steps 303 and 304 are executed with i varied from 1 to M/4 and j varied from 1 to M/4. As a result of these processes, every block of the up-sampled texture component image A is replaced with a similar block in the reference high-resolution texture component image B.

However, if the smallest summed difference calculated for a block is larger than a predetermined value, that is, if a degree of similarity (e.g. the inverse of the smallest summed difference) is smaller than a predetermined value, the replacement described above is not performed for the block and a block of the prepared up-sampled texture component image A which is prepared beforehand by linear interpolation is used as it is.

By using the above-described learning-based up-sampling portion 10 in constructing the image processing devices in FIG. 1 or 2, it becomes possible to obtain a super-resolution image having improved image resolution.

Although the size of each block of the input texture component image is set to 4×4 pixels in the embodiment described above, the size of each block is not limited to this but can be arbitrary set to N×N in a generalized manner.

The selected blocks Bk.l only have to be located to the corresponding blocks Ai,j of the up-sampled texture component image. Other than the replacement of blocks described above, the selected blocks Bk,l may be, for example, inserted in the corresponding blocks Ai,j of the up-sampled texture component image if all blocks of the up-sampled texture component image A have been cleared at the onset of execution of the processes in FIG. 5.

The image processing devices shown in FIGS. 1 and 2 can be realized by a computer and software. In this case, each of the portions 1, 2, 4 to 7, 9, 10 shown in FIGS. 1 and 2 may be a single microcomputer, and each microcomputer may execute image processing programs for realizing all of its functions in order to realize these functions. Otherwise, the portions 1, 2, 4, and 10 shown in FIG. 1 (or the portions 5 to 10 shown in FIG. 2) may constitute a single microcomputer as a whole, and this microcomputer may execute image processing program for realizing all functions of the portions 1,2, 4, and 10 (or the portions 5 to 10) which this microcomputer serves as in order to realize these functions. In each case, each of the portions 1, 2, 4 to 7, 9, 10 is comprehended as a means (or a portion) for realizing the portion, and image processing programs are composed by the means or the portions. Otherwise, the above-described microcomputers may be replaced with an IC circuit (e.g. FPGA) having circuit compositions for realizing the functions of the microcomputers.

That is, what is shown in FIG. 1 can be realized as an image processing program for causing a computer to serve as a decomposing means for decomposing an input image into a structure component and a texture component, a structure component up-sampling means for up-sampling the structure component, a texture component up-sampling means for up-sampling the texture component, and a component mixing means for mixing the up-sampled structure component and the up-sampled texture component. What is shown in FIG. 2 can be realized as an image processing program for causing a computer to serve as a structure component up-sampling means (a TV regularization means) for up-sampling a structure component of an input image, a down-sampling means for down-sampling the up-sampled structure component to obtain a structure component which has the same number of samples as the input image, a subtracting means for subtracting the texture component obtained by the down-sampling means from the input image to obtain a texture component, a texture component up-sampling means for up-sampling the texture component obtained by the subtracting means, and a component mixing means for mixing the up-sampled structure component and the up-sampled texture component. In these image processing programs, the texture component up-sampling means operates by reading a reference high-resolution texture component image and a reference low-resolution texture component image, selecting the most similar block to each of blocks obtained by dividing the texture component image wherein the most similar block is selected from a plurality of blocks obtained by dividing the reference low-resolution texture component image in the same manner as the division of the reference low-resolution texture component, and using blocks of the reference high-resolution texture component image corresponding to the selected blocks to form corresponding blocks of the up-sampled texture component image.

Since there are several kinds of learning-based methods as is described in ‘Yasunori Taguchi, Toshiyuki Ono, Takeshi Mita, and Takashi Ida, “A Learning Method of Representative Examples for Image Super-Resolution by Closed-Loop Training”, IEICE Trans., Vol. J92-D, No. 6, pp. 831-842, 2009’ (which is incorporated by reference), it is possible to use other learning-based methods in place of the learning-based method described above.

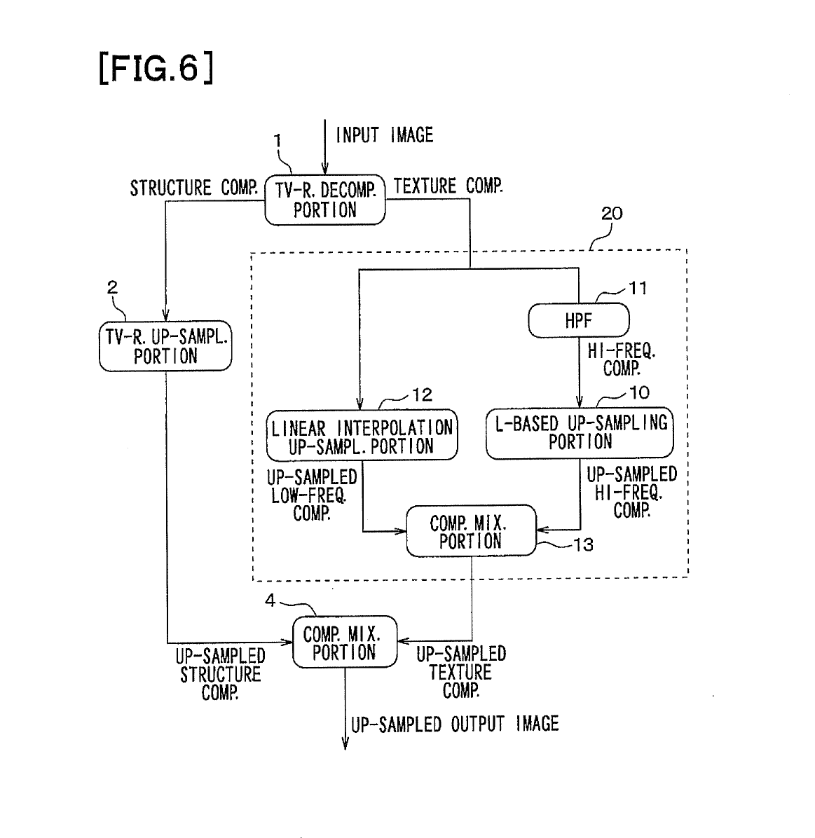

Next, a third embodiment of the present invention is described. The image processing device according to a third embodiment is obtained by modifying the composition of the image processing device according to a first embodiment (see FIG. 1) to that shown in FIG. 6. That is, the learning-based up-sampling portion 10 in FIG. 1 is replaced with a unit 20.

The unit 20 of a third embodiment includes a learning-based up-sampling portion 10, an HPF (high pass filter portion) 11, a linear interpolation up-sampling portion 12, and a component mixing portion 13. The texture component (input texture component image a) which is outputted by the TV regularization decomposing means 1 is inputted to the HPF 11 (high pass filter portion) and the linear interpolation up-sampling portion 12.

The linear interpolation up-sampling portion 12 uses linear interpolation to up-sample the input texture component image a by the same ratio (e.g. by 2 in the vertical and the horizontal directions) with the learning-based up-sampling portion 10 and obtain an up-sampled low frequency image, and inputs the up-sampled low frequency image into the component mixing portion 13. This up-sampled low frequency image is lacking the high frequency component.

In order to reconstruct the high frequency component, the HPF 11 obtains a high frequency component of the input texture component image a and input them into the learning-based up-sampling portion 10. The learning-based up-sampling portion 10 in FIG. 6 is different from the learning-based up-sampling portions 10 in FIGS. 1 and 2 in that an image to be inputted to the learning-based up-sampling portion 10 in FIG. 6 is not a mare input texture component image a but the high frequency component of the input texture component image a. However, details of the processes for the inputted image are the same as those of the learning-based up-sampling portions 10 in FIGS. 1 and 2. Therefore, the learning-based up-sampling portion 10 in FIG. 6 utilizes a learning-based method using the reference texture component images B and b (or high frequency reference texture component images which are obtained by extracting the high frequency component of the reference texture component images B and b) to up-sample the high frequency component of the input texture component image a, obtains an up-sampled high frequency component as a result of the up-sampling, and inputs the up-sampled high frequency component into the component mixing portion 13.

The component mixing portion 13 mixes (more specifically, calculating each sum of corresponding pixels in) the up-sampled low frequency component inputted from the linear interpolation up-sampling portion 12 and the up-sampled high frequency component inputted from the learning-based up-sampling portion 10 to obtain an up-sampled texture component and inputs the up-sampled texture component into the component mixing portion 4.

As described above, by up-sampling only the high frequency component of the texture component at the learning-based up-sampling portion 10 to obtain the up-sampled high frequency component and by mixing the up-sampled high frequency component and the up-sampled low frequency component to obtain the up-sampled texture component, it becomes possible to up-sample the low frequency component of the input texture component image by means of the linear interpolation while keeping information of the input texture component image, and also obtain a high-definition image by applying the learning-based method selectively to the high frequency component which contribute a lot to the quality of the image.

The learning-based up-sampling portion 10 in FIG. 6 may determine a reference block for an original block wherein the reference block has the smallest summed difference to the original block, and may set the pixel values of the blocks of the up-sampled texture component (a high-resolution up-sampled texture component) corresponding to the original block to zero if the summed difference of the determined reference block is larger than a predetermined value, that is, if the reference block has a degree of similarity to the original block which is smaller than a predetermined degree of similarity. In this case, the corresponding block of the up-sampled texture component outputted from the component mixing portion 13 only includes the output of the linear interpolation up-sampling portion 12.

In other words, the unit 20 selects, for each of the original blocks, a reference block which is most similar to the original block of all reference blocks having a degree of similarity to the original block being larger than a predetermined value if the reference blocks includes at least one reference block having a degree of similarity to the original block being larger than a predetermined value. Then the unit 20 forms a block of the up-sampled texture component corresponding to the original block by using (more specifically, mixing) the block of the reference high-resolution images (the reference texture component images B or their high-resolution component) corresponding to the selected reference block and the block corresponding to the original block in the up-sampled texture component obtained by the linear interpolation. If the reference blocks does not include a reference block having a degree of similarity to the original block being larger than the predetermined value, the unit 20 does not use the reference blocks but uses the block corresponding to the original block in the up-sampled texture component obtained by the linear interpolation in order to form the block of the up-sampled texture component corresponding to the original block.

The image processing devices shown in FIG. 6 can be realized by a computer and software. In this case, each of the portions 1, 2, 4, and 10 to 13 shown in FIG. 6 may be a single microcomputer, and each microcomputer may execute image processing programs for realizing all of its functions in order to realize these functions. Otherwise, the portions 1, 2, 4, and 10 to 13 shown in FIG. 6 may constitute a single microcomputer as a whole, and this microcomputer may execute image processing program for realizing all functions of the portions 1,2, 4, and 10 to 13 which this microcomputer serves as in order to realize these functions. In each case, each of the portions 1, 2, 4, and 10 to 13 is comprehended as a means (or a portion) for realizing the portion, and image processing programs are composed by the means or the portions. Otherwise, the above-described microcomputers may be replaced with an IC circuit (e.g. FPGA) having circuit compositions for realizing the functions of the microcomputers.

Thus the image processing devices according to first to third embodiments include a decomposing and up-sampling means (1, 2, 5, 6, 7) for outputting an up-sampled structure component and a texture component of an input image, a texture component up-sampling means (10, 20) for up-sampling the texture component, and a component mixing means (4, 9) for mixing the up-sampled structure component and an up-sampled texture component obtained by the texture component up-sampling means (10, 20), wherein the texture component up-sampling means (10, 20) up-samples the texture component by means of a learning-based method using a reference image.

### Other Embodiments

Although embodiments of the present invention are described as above, the present invention is not limited to the above embodiment but includes various embodiments which can realize each feature of the present invention. For example, the present invention allows the following embodiments.

For example, the learning-based up-sampling portions 10 in the first and second embodiments select, for each of the original blocks, a reference block which is most similar to the original block of all reference blocks, select a block of the reference high-resolution images corresponding to the selected reference block, and replace, with the selected block of the reference high-resolution image, a block of the up-sampled texture component up-sampled by means of linear interpolation. However, the learning-based up-sampling portions 10 do not have to do this way. For example, as is done in a third embodiment, the learning-based up-sampling portions 10 may add the selected block of the reference high-resolution image to a block of the up-sampled texture component up-sampled by means of linear interpolation and outputs a resultant image as a final up-sampled texture component. In this case, the learning-based up-sampling portions 10 selects, for each of the original blocks, a reference block which is most similar to the original block of all reference blocks having a degree of similarity to the original block being larger than a predetermined value if the reference blocks includes at least one reference block having a degree of similarity to the original block being larger than a predetermined value. Then the learning-based up-sampling portions 10 forms a block of the up-sampled texture component corresponding to the original block by using (more specifically, mixing) the block of the reference high-resolution images (the reference texture component images B) corresponding to the selected reference block and the block corresponding to the original block in the up-sampled texture component obtained by the linear interpolation. If the reference blocks does not include a reference block having a degree of similarity to the original block being larger than the predetermined value, the learning-based up-sampling portions 10 does not use the reference blocks but uses the block corresponding to the original block in the up-sampled texture component obtained by the linear interpolation in order to form the block of the up-sampled texture component corresponding to the original block.

The learning-based up-sampling means 10 may execute the following processes at steps 303 and 304 instead of executing the above-described processes. At step 303, the learning-based up-sampling means 10 reads the original blocks ai,j of the texture component image a one by one from the storage device such as the RAM and performs comparison by calculating a difference between each of the read original blocks ai,j and every reference block bk,l of every reference low-resolution texture component image b in the storage device such as the ROM, and obtain the summed difference within the single block. Then, the learning-based up-sampling portion 10 selects a plurality (for example, a predetermined number that is three) of top reference blocks bk,l having the smallest summed difference, that is, having the most similar image to each original block ai,j. Subsequently, the learning-based up-sampling portion 10 selects a plurality of blocks Bk,l which corresponds to the selected reference blocks bk,l. Then, at step 304, the learning-based up-sampling portion 10 calculates each weighed average (e.g. simple arithmetic average) of the plurality of pixels representing an identical position by using the plurality of selected blocks Bk,l in the storage device such as the ROM. Then, the learning-based up-sampling portion 10 replaces the block Ai,j of the up-sampled texture component image A with the replacement block obtained as a result of the calculation wherein the replacement block corresponds to a linear sum of the plurality of selected blocks Bk,l. This operation is repeated with i varied from 1 to M/4 and j varied from 1 to M/4. As a result of this operation, every block of the up-sampled texture component image A is replaced with an image (the linear sum) based on similar blocks in the reference high-resolution texture component image B. Otherwise, as is described above, the learning-based up-sampling means 10 may mix the linear sum of the similar blocks in the reference high-resolution texture component image B and a corresponding block of the texture component image which has been up-sampled by the linear interpolation up-sampling.

In first to third embodiments, each of the reference high-resolution texture component images B and each of the reference low-resolution texture component images b may be stored in advance in the storage device such as the ROM with pixel values in the entire region thereof preserved. Otherwise, each of the reference high-resolution texture component images B and each of the reference low-resolution texture component images b may be stored in advance in the storage device such as the ROM with pixel values in a part of the entire region thereof discarded. In the latter case, the only blocks in the non-discarded region of the reference low-resolution texture component images b are read as the reference blocks to compare with the original blocks.

A texture component image includes more blocks which are almost identical to each other in pixel values than a normal image includes. Therefore, using texture component images as reference images can increase discarded parts of the reference images and thereby improve processing speed of the learning-based up-sampling portion 10.

### REFERENCE SIGNS LIST

1 TV regularization decomposing portion
2 TV regularization up-sampling portion
3 linear interpolation up-sampling portion
4 component mixing portion
5 TV regularization up-sampling portion
6 subtracting portion
7 down-sampling portion
8 linear interpolation up-sampling portion
9 component mixing portion
10 learning-based up-sampling portion
11 HPF
12 linear interpolation up-sampling portion

1. A image processing device comprising:
a texture component up-sampling portion for up-sampling a texture component of an input image to obtain an up-sampled texture component; and
a component mixing portion for mixing an up-sampled structure component of the input image and the up-sampled texture component obtained by the texture component up-sampling portion,
wherein the texture component up-sampling portion up-samples the texture component by means of a learning-based method using a reference image.

2. The image processing device according to claim 1, wherein the up-sampled structure component and the texture component is obtained by means of a TV regularization method.

3. The image processing device according to claim 1, wherein the reference image is a texture component image.

4. The image processing device according to claim 1, further comprising a structure component up-sampling portion for up-sampling a structure component of the input image by means of a TV regularization method, wherein
the component mixing portion mixes the up-sampled structure component obtained by the structure component up-sampling portion and the up-sampled texture component obtained by the texture component up-sampling portion.

5. The image processing device according to claim 1, further comprising:
an up-sampled structure component obtaining portion for obtaining the up-sampled structure component based on the input image;
a down-sampling portion for down-sampling the up-sampled structure component and thereby obtain a structure component having the same number of samples as the input image; and
a subtracting portion for obtaining the texture component by subtracting the structure component obtained by the down-sampling portion from the input image, wherein
the texture component up-sampling portion up-samples the texture component obtained by the subtracting portion.

6. The image processing device according to claim 1, wherein the texture component up-sampling portion includes:
a storage portion for storing a reference low-resolution image which is obtained by down-sampling the reference image and a reference high-resolution image serving as the reference image; and
a portion for selecting, for each of original blocks obtained by dividing an image based on the texture component into blocks, at least one reference block similar to the original block out of reference blocks obtained by dividing the reference low-resolution image into blocks, and forming a block of the up-sampled texture component corresponding to the original block by using at least one block of the reference high-resolution image corresponding to the at least one reference block.

7. The image processing device according to claim 6, wherein the portion for selecting selects, for each of the original blocks, a reference block which is most similar to the original block of all of the reference blocks, selects a block of the reference high-resolution image corresponding to the selected reference block, and forms a block of the up-sampled texture component corresponding to the original block by using the selected block of the reference high resolution image.

8. The image processing device according to claim 6, wherein
the texture component up-sampling portion includes a linear interpolation up-sampling portion for obtaining a provisional up-sampled texture component based on the input image by means of linear interpolation, and
the portion for selecting selects, for each of the original blocks, at least one reference block similar to the original block out of the reference blocks, and forms a block of the up-sampled texture component corresponding to the original block by using both of at least one block of the reference high-resolution image corresponding to the at least one reference block and a block corresponding to the original block in the provisional up-sampled texture component obtained by the linear interpolation up-sampling portion, if the reference blocks includes at least one reference block having a degree of similarity to the original block being larger than a predetermined value, and
the portion for selecting forms a block of the up-sampled texture component corresponding to the original block by not using the reference blocks but using a block corresponding to the original block in the provisional up-sampled texture component obtained by the linear interpolation up-sampling portion if the reference blocks does not include a reference block having a degree of similarity to the original block being larger than the predetermined value.

9. A image processing program for causing a computer to serve as:
a texture component up-sampling portion for up-sampling a texture component of an input image to obtain an up-sampled texture component; and
a component mixing portion for mixing an up-sampled structure component of the input image and the up-sampled texture component obtained by the texture component up-sampling portion,
wherein the texture component up-sampling portion up-samples the texture component by means of a learning-based method using a reference image.

10. A method for generating an image from an input image wherein the generated image is obtained by up-sampling the input image, comprising.
a decomposing and up-sampling process for obtaining an up-sampled structure component of the input image and obtaining a texture component of the input image;
a texture component up-sampling process for up-sampling the texture component obtained by the decomposing and up-sampling process to obtain an up-sampled texture component; and
a component mixing process for mixing the up-sampled structure component obtained by the decomposing and up-sampling process and the up-sampled texture component obtained by the texture component up-sampling process,
wherein the texture component is up-sampled by means of a learning-based method using a reference image in the texture component up-sampling process.

11. The motor drive device according to claim 1, wherein
the texture component up-sampling portion includes a learning-based up-sampling portion, a high pass filter portion, a linear interpolation up-sampling portion, and another component mixing portion,
the texture component is inputted to the high pass filter portion and the linear interpolation up-sampling portion,
the linear interpolation up-sampling portion obtains an up-sampled low frequency image by up-sampling the texture component by means of linear interpolation and inputs the up-sampled low frequency component to the another component mixing portion,
the high pass filter obtains a high frequency component of the texture component and inputs the high frequency component to the learning-based up-sampling portion,
the learning-based up-sampling portion up-samples the inputted high frequency component by means of a learning-based method using a reference image and inputs the up-sampled high frequency component to the another component mixing portion,
the another component mixing portion obtains an up-sampled texture component by mixing the up-sampled low frequency component inputted from the linear interpolation up-sampling portion and the up-sampled high frequency component inputted from the learning-based up-sampling portion, and inputs the up-sampled texture component into the component mixing portion.
